(19) United States
(12) Patent Application Publication
(10) Pub. No.: US 2010/0124934 A1
(43) Pub. Date: May 20, 2010

(54) Wireless System Improvements Based On Location Positioning System Data

(75) Inventor: Tomasz Mach, Fleet (GB)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/621,609

(22) Filed: Nov. 19, 2009

Related U.S. Application Data
(60) Provisional application No. 61/199,797, filed on Nov. 20, 2008.

(51) Int. Cl. H04W 24/00

(52) U.S. Cl. 455/456.1

(57) ABSTRACT

An apparatus is disclosed that includes using a first wireless network to determine a position of portable user equipment, and the portable user equipment setting one or more operational conditions of the portable user equipment for one or both of operating in or accessing a second wireless network using the determined position. An apparatus is disclosed that includes a radio frequency transceiver, one or more processors able to communicate with the radio frequency transceiver, and one or more memories including computer program code. The one or more memories and the computer program code are configured to, with the one or more processors, cause the apparatus to perform at least the following: using a first wireless network to determine a position of the apparatus; and setting one or more operational conditions of the apparatus for one or both of operating in or accessing a second wireless network using the determined position.

### CROSS-REFERENCE TO RELATED APPLICATIONS

The present application claims the benefit under 35 U.S.C. §119(e) of U.S. Provisional Patent Application No. 61/199,797, filed on Nov. 20, 2009, the disclosure of which is hereby incorporated by reference in its entirety.

### TECHNICAL FIELD

The exemplary and non-limiting embodiments of this invention relate generally to wireless communication systems, methods, devices and computer programs and, more specifically, relate to using position information from a first network (e.g., GPS) for improving performance in or of a second network (e.g., terrestrial cellular).

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
GPS global positioning system
eNB EUTRAN Node B (evolved Node B)
E-UTRAN evolved UTRAN (also known as LTE or 3.9G)
GSM global system for mobile communications
HO handover
LTE long term evolution
Node B base station
O&M operations and maintenance
RAT radio access technology
RSSI received signal strength indication
S GW serving gateway
SON self organizing network
UE user equipment
UMTS universal mobile telecommunications system (also known as 3G)
UTRAN UMTS terrestrial radio access network
WCDMA wideband code division multiple access
WRAN wireless radio access network

Various terrestrial mobile telephony networks operate using signal strength to estimate a mobile terminal's position or speed. For example, layer 1 (L1) algorithms currently deployed in 3G UMTS networks take into account only criteria based on measured radio signal quality, for example, the ratio of received signal energy per chip to power density in the band (Ec/Io), or received signal code power (RSCP). The wireless radio access network (WRAN) protocol stack does not take into account any data that is specific to the exact or actual location of the mobile terminal/portable user equipment. This observation is shown by three examples.

In the WCDMA system, there is a multiband cell search algorithm by which a UE will search for a cell (base station/access node) blindly across multiple frequency bands for which it is capable. This is both time and power consuming; it can take up to a full minute to measure six different frequency bands before the UE can find a suitable cell for establishing contact. This blind detection is sometimes necessary when the UE does not know its position prior to the search, and so the algorithm searches through all frequency bands until a suitable cell is found.

In the LTE (and also the UMTS) system, there is proposed different mobility modes for the UE which determines how a timer for re-selection is set within the UE. Fast moving UEs are put in a high mobility state and have a shorter timer than slower moving or stationary UEs which are put in a low mobility state. Currently the algorithm sets the mode based on two parameters that are signaled from the network itself: number of cell reselections by the UE (N) in a defined period of time (T). If the UE has made more than N reselections in any time window of T duration, then the high mobility state is entered (or detected if already in the high mobility state). It is desirable to apply different cell reselection times depending on the UE mobility state because the reselection timer decides when the UE should reselect to a new cell. It is further used to prevent a false re-selection decision due to a power spike that does not genuinely reflect that the neighbor cell has a larger signal strength. That the network configures these parameters N and T introduces a delay and a potential for error if the network does not configure these parameters properly, particularly for high mobility UEs. The above approach also assumes proper tuning of the network itself, which introduces a high O&M requirement on the network to assure that different received signal strengths correspond to specific physical locations.

There is another algorithm that requires the UE to begin measurement reports of neighbor cells based on the relative power (RSSI) of the serving cell. If the power of the current serving cell goes below certain thresholds (which may be different for intra-RAT and inter-RAT frequencies, where RAT is radio access technology), then the UE starts to measure power of the neighbor cells. For the case that the UE is not moving, this approach is seen to unnecessarily consume the UE's battery power since if the phone is not moving there is seldom if ever a need to frequently measure the power of any cell; that power would remain quite stable for a non-moving UE.

Noted above was the network's O&M requirement of tuning. As currently understood, field coverage measurements are performed by specialized mobile units (e.g., a vehicle with mobile network measurement equipment operated by the network). This process is quite costly, but the operators of the mobile wireless network need very precise information about their network coverage which they use to generate field coverage maps in terms of Ec/Io and/or RSSI for proper management of UEs moving through the various cells, and for other network planning and maintenance processes. Because the network configuration is dynamic, mobile network operators need to repeat field measurements after any reconfigurations are done in the network to update these coverage maps.

With the increased functionality of more recent mobile terminals, the above algorithms and processes may be improved according to exemplary embodiments of the teachings detailed below. Also there is a 3GPP Self Organizing Network (SON) concept introduced in LTE system. The basic idea of the concept is that a mobile network with measurement support from UE is able to automatically adjust/tune its parameters. Embodiments of this invention may be used in support of the SON concept.

### BRIEF SUMMARY

In a first aspect, a method is disclosed that includes using a first wireless network to determine a position of a portable user equipment. The method also includes the portable user equipment setting one or more operational conditions of the portable user equipment for one or both of operating in or accessing a second wireless network using the determined position.

In a second aspect, an apparatus is disclosed that includes a radio frequency transceiver, one or more processors able to communicate with the radio frequency transceiver, and one or more memories including computer program code. The one or more memories and the computer program code are configured to, with the one or more processors, cause the apparatus to perform at least the following: using at least the radio frequency transceiver, using a first wireless network to determine a position of the apparatus; and setting one or more operational conditions of the apparatus for one or both of operating in or accessing a second wireless network using the determined position.

In a third aspect, a computer program product is disclosed that includes a computer-readable medium bearing computer program code embodied therein for use with a portable user equipment. The computer program code includes code for using a first wireless network to determine a position of the portable user equipment, and code for causing the portable user equipment to set one or more operational conditions of the portable user equipment for one or both of operating in or accessing a second wireless network using the determined position.

In a fourth aspect, an apparatus is disclosed that includes means for using a first wireless network to determine a position of a portable user equipment, and means for causing the portable user equipment to set at least one operational condition of the portable user equipment for one or both of operating in or accessing a second wireless network using the determined position.

### BRIEF DESCRIPTION OF THE DRAWINGS

FIG. 1 illustrates a portable user equipment operating in two different wireless networks according to an exemplary environment in which these teachings may be practiced.

FIG. 2 is a logic flow diagram that illustrates the operation of a method, and may be, e.g., a result of execution of computer program instructions embodied on a computer readable memory, in accordance with one exemplary embodiment of this invention.

FIG. 3A shows a simplified block diagram of various electronic devices that are suitable for use in practicing the exemplary embodiments of this invention.

FIG. 3B shows a more particularized block diagram of a portable user equipment such as that shown at FIG. 3A.

FIG. 4 is a logic flow diagram that illustrates the operation of a method, and may be, e.g., a result of execution of computer program instructions embodied on a computer readable memory, in accordance with the exemplary embodiments of this invention.

### DETAILED DESCRIPTION

Considering the progressing evolution of mobile terminals in view of the above examples by which signal strength is used to determine the UEs speed, embodiments of the present invention employ a new criteria which can be considered in those and other algorithms to optimize the usage of available network resources and/or increase the service quality as a result. Specifically, global positioning system (e.g., GPS, though any positioning system can be used apart from GPS) information is now available in more advanced UEs, which creates the possibility to use this more precise data as an input to algorithms deployed in cellular networks such as the L1-L3 WCDMA/LTE radio protocol stack noted by example in background above.

Consider that there are two parameters provided by a UE integrated location positioning system (i.e., GPS receiver) that may be included in an advanced mobile terminal: the current geographical location of the UE, and the current speed of the UE. The UE may obtain multiple positions over a window of time and compute its speed from the elapsed distance over the elapsed time window. That computation may be done in the GPS receiver itself or in another processor of the UE.

These two new parameters can be used as an additional input or as a replacement input to estimated position/speed in many existing L1-L3 (and other) radio protocols and algorithms used in mobile phones to improve their performance, particularly when operating in a mobile network operating on protocols developed many years ago such as for example UMTS, though these teachings may also be used in other radio access technology systems such as LTE, WIMAX etc.

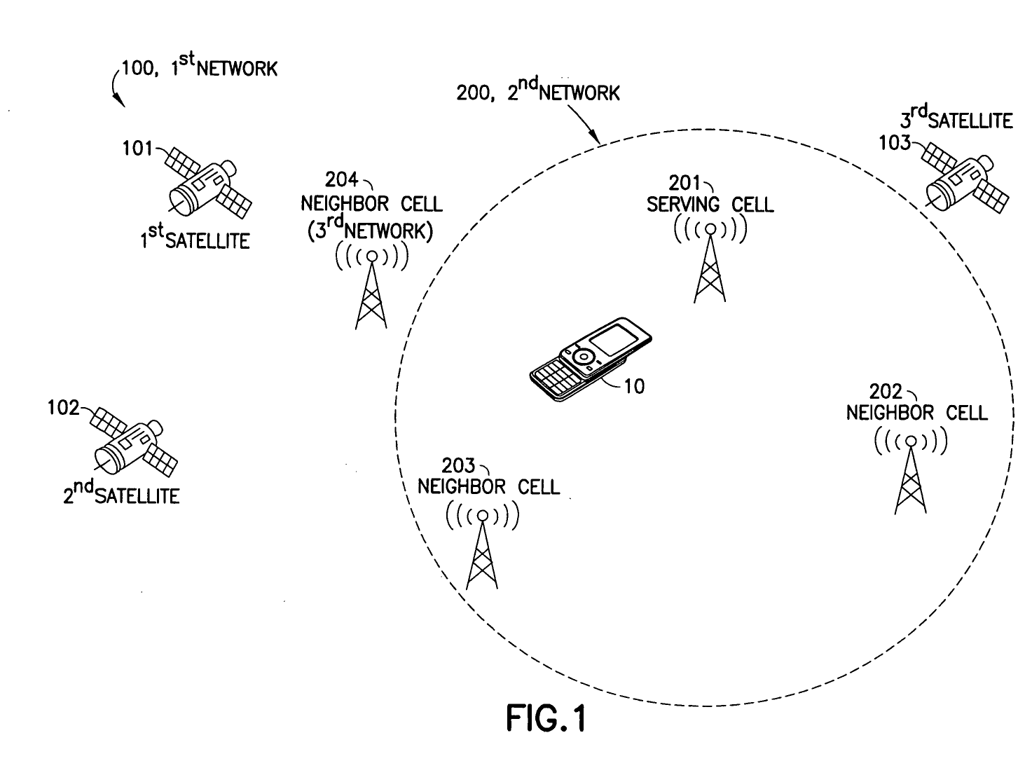

FIG. 1 illustrates an environment in which such teachings may be employed. A mobile/portable UE 10 has access to a first wireless network 100 which is in this example a non-terrestrial positioning network (e.g., GPS). The first wireless network 100 is not limited to a non-terrestrial positioning network but may also be a terrestrial positioning network in other embodiments, which the UE uses to determine its position/speed. As is known, the GPS receiver in the UE 10 fixes its position from signals received from multiple GSP satellites (1st GPS satellite 101, 2nd GPS satellite 102 and 3rd GPS satellite 103 shown). The extent of the first network 100 may be considered the entire page of FIG. 1, and fully encompasses a second wireless network 200 which is a terrestrial mobile telephony network such as UMTS, E-UTRAN and GSM which are non-limiting examples of hierarchical terrestrial wireless networks.

The second wireless network has a plurality of cells represented by access nodes termed as base stations, nodeBs, e-NBs, or otherwise. Shown is a serving cell 201 and neighbor cells 202, 203 which are within the second wireless network, as well as an additional neighbor cell 204 which is within a third wireless network that is also terrestrial but which may be a different radio access technology RAT than that of the second wireless network 200. Some algorithms for which the UE's GPS information might be used according to these teachings relate to the taking of measurements and the sending of measurement reports concerning those neighbor cells which may be within the second network 200 (e.g., cells 202, 203) and/or which may lie in a separate third network (e.g., cell 204).

Consider again the three algorithms noted in background above. In the multiband initial cell search algorithm, the UE is looking for any cell through many bands. The low/medium/high (e.g. medium state introduced in 3GPP LTE system) mobility mode detection is used in an L1 cell reselection algorithm. The cell power measurements are done in the idle (and/or in the active) mode and are used in a different L1 cell reselection algorithm and also in the handover algorithm. Each of these algorithms can be improved using the UE's positional data (position, speed) obtained from the non-terrestrial network 100. A technical aspect is that there may be a reduction in the current consumption by searching through fewer bands in the initial search algorithm and by conducting fewer neighbor cell measurements when the UE is not moving or slowly moving, and more accurate and more real-time decisions on the UE's mobility mode.

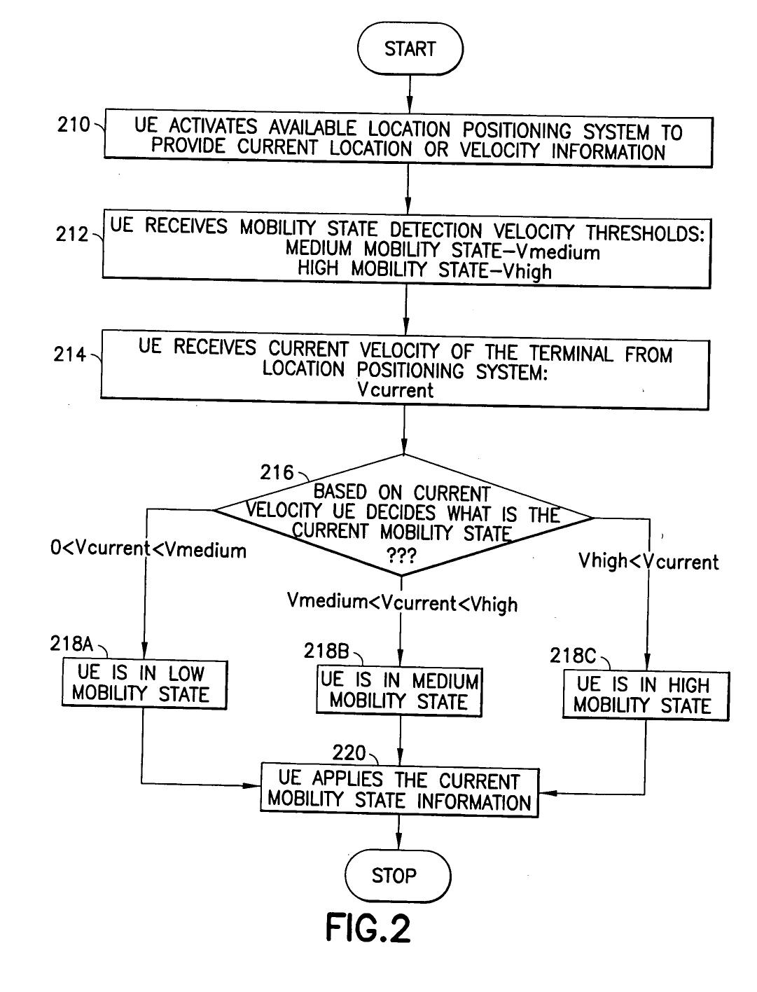

FIG. 2 is a logic flow diagram that illustrates the operation of a method (and may be, e.g., a result of execution of computer program instructions embodied on a computer readable memory) in accordance with one exemplary embodiment of this invention related to the mobility state determination noted above. At block 210 the UE activates its location positioning system (e.g., GPS receiver) to provide its current position information. By accumulating multiple positions over time the UE can determine the distance moved over that time and thus determine its speed, which may be done at block 210 or using the positions obtained at blocks 210 and 214. At block 212 the UE receives from the network the mobility state detection thresholds which define the different velocity states: UE speed between Vmedium and Vhigh corresponds to the medium mobility state; UE speed below Vmedium corresponds to the low mobility mode; and UE speed above Vhigh corresponds to the high mobility mode. The network may define speeds equal to these thresholds as either in the lower one or the higher one of the mobility states that are divided by the particular threshold.

At block 214 the UE obtains another position for itself from the location positioning system (e.g., the GPS system) and either computes its speed using the first position obtained at block 210 or updates the speed it calculated there for itself. There is a decision at block 216 as to what mobility state the UE should be in based on comparing the speed obtained at block 214 (or 210) to the thresholds obtained from the mobile telephony network at block 212. The tri-part decision results are shown at blocks 218A for the low mobility state, 218B for the medium mobility state, and 218C for the high mobility state. The decision is used internally within the UE to change its mobility state according to the decision at block 216, and at 220 the UE applies the current mobility state information. In one specific embodiment, the current mobility state information is applied by the UE setting a timer which indicates how frequently the UE is to measure and report neighbor cells 202-204 to the serving node 201 of the terrestrial network 200. The serving cell 201 uses these neighbor cell measurement reports for cell reselection and handover decisions for the UE 10. The high mobility state UE sets the timer shorter so its reports are more frequent; the low mobility state UE sets the timer longer and its reports are less frequent, and the medium mobility state UE lies between those two extremes.

The second network 200 might also put the UE's positional data which the UE obtains from the first network 100 to use, for example in its O&M functions. Some terrestrial mobile telephony networks 200 currently use Ec/Io information and RSSI information that the UE reports for tuning the network. This alone is insufficient for proper tuning; the terrestrial networks generally had to send out physical vehicles to different locations to verify positions at which certain values of Echo and RSSI were experienced. This physical position data was then used to correlate the UE-reported information with physical layout of the network, which may cause variations to Ec/Io and RSSI based on factors other than simple distance from the cell (e.g., attenuation from buildings or topology, interference due to crossover from other radio towers/transceivers, etc.). Also, operation of certain cells may be modified at different times of day based on traffic conditions; some cells shrinking the geographic area they cover while others may expand to assure contiguous coverage. WCDMA systems engage in such network tuning.

According to embodiments of this invention, the above WCDMA/LTE L1-L3 radio protocol algorithms in the UE which previously reported Ec/Io and RSSI for example are expanded to report to the second network 200 also the UE's position which was obtained from the first, positioning network 100. The UE's signal strength report would then in certain embodiments include the information triplet [geographical location from the first positioning network 100, Ec/Io, RSSI]. Instead of or in addition to RSSI, the UE can include in the report it sends to the second network 200 some other UE received signal related strength or performance data. The second network 200/serving cell 201 receiving such a triplet then stores this enhanced reporting information in a database connected to the network equipment. This database can be then used by a network operator to provide very accurate network coverage at different times of the day, at different physical locations, etc.

These data triplets can be sent from the UE to the network periodically (i.e. during location update procedures) or only when requested by a network in dedicated signaling. This additional information provided can significantly improve the operator's knowledge of his network coverage and be very useful for network maintenance or troubleshooting network problems. Because many UEs operating in a terrestrial network can be involved in such measurements, the terrestrial network operator is able to quickly receive valid and complete information about current network coverage (e.g. by requesting measurement reports from randomly selected UEs in particular cell, area). This solution in which the terrestrial/second network stores and analyzes coverage measurements that include location information (e.g., GPS) from the reporting UEs has the potential to dramatically reduce the need for inefficient and expensive field measurements by physically roaming network equipment.

From the UE's perspective, the location position information (e.g., from the GPS/first network 100) it obtains for itself may also be used in its initial access of the terrestrial/second network 200. In the multiband cell search algorithm, the UE's GPS position may be used by the UE to limit the number of frequency bands that it searches to a smaller number than the cell search algorithm tells it to search through. For example, if the UE is quad band and is capable of searching bands used in the US (United States), Japan and the EU (European union), then once the GPS position fixes the UE to lie within the US the UE can conclude it need not search in the frequency bands that are used only in Japan or only in the EU. The granularity of how much the band search can be limited depends on the granularity of the table stored within the local memory of the UE that associates different frequency bands with different physical locations. The relatively small database of the exact geographical band location as in the above example can be periodically updated from the Internet or from the terrestrial/second network 200 and stored in the UE's local memory. This use of these teachings can dramatically reduce the initial cell search time and service availability for the user. This may be enabled if the UE obtains current geographical location position (e.g., GPS) data from the first network 100 prior to undertaking the multiband cell search to find the second network 200, or using a previously stored GPS location prioritize the bands searched prior to an updated/current GPS position being determined.

Similarly, UE speed data obtained from the first positioning network 100 may be used to limit the frequency of cell power measurements made while the UE is in an idle mode. While in the idle mode the UE is still operating within the terrestrial/second network 200, but is within a discontinuous reception period DRX (or discontinuous transmission period DTX). A reduced frequency of these cell measurements (neighbor cells 201-204 and current serving cell 201) can increase battery life in the UE significantly by reducing their frequency when the UE is currently not moving or moving very slowly (e.g., walking speed). When the UE increases its speed such as when a user begins to drive or ride away in a vehicle, the frequency of the cell measurements is increased accordingly. This implementation is similar in concept to the mobility mode noted in detail above and with respect to FIG. 2.

By using current UE location or velocity data information available from the location positioning system 100, it is possible to decide if the UE is currently not moving, or moving slowly, or moving quickly. It is noted that although GPS is the most popular system integrated into current and future mobile terminals, these teachings are not limited to the GPS system or even to a non-terrestrial system, but may use some other positioning system that becomes available in the future. Based on the location or velocity information received, the UE radio resource management (RRM) protocol can determine the current mobility state (e.g., low/medium/high) and apply that information to radio algorithms internal to the UE. Non-limiting examples include cell handover/reselection, such as where a cell diversity concept is applied so as to bias the preferred cells for a handover/reselection, bias macro/larger cells for fast moving terminals, and bias pico/smaller cells for slowly moving terminals.

The various algorithms affected by these teachings may be triggered after every cell handover/re-selection. Alternatively, the triggering frequency, or the triggering of using the UE's positional/speed information as an input to one of those algorithms, may be configured by the network and signaled to the UE that is to implement that modified input to the algorithm.

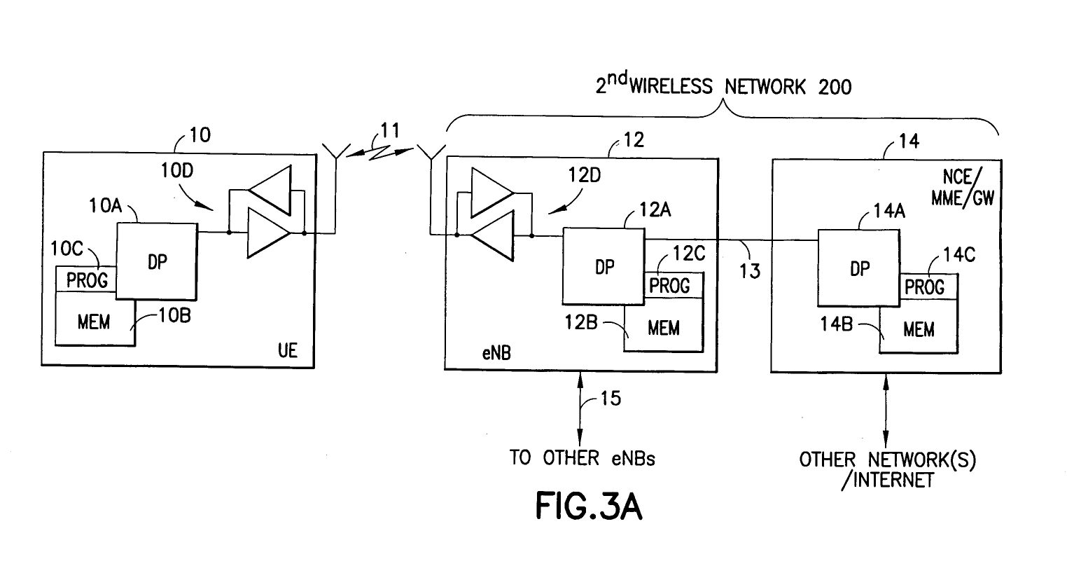

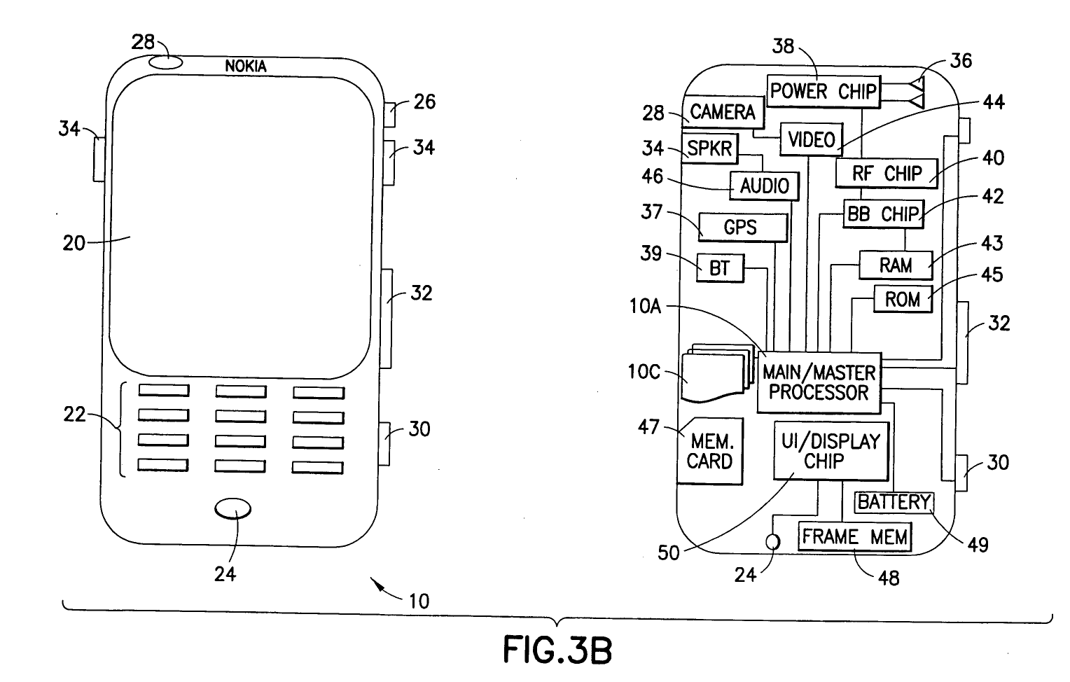

Reference is now made to FIG. 3A for illustrating a simplified block diagram of various electronic devices and apparatus that are suitable for use in practicing the exemplary embodiments of this invention, at least from the UE's perspective of implementation. In FIG. 3A a wireless network 200 is adapted for communication over a wireless link 11 with an apparatus, such as a mobile communication device which may be referred to as a UE 10, via a network access node, such as a Node B (base station), and more specifically an eNB 12. The network 200 may include a network control element (NCE) 14 that may include mobility management/serving gateway (MME/S GW) functionality as is known in the art, and which provides connectivity with other networks as shown, such as a publicly switched telephone network and/or a data communications network (e.g., the Internet). The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable radiofrequency RF transceiver 12D for communication with the UE 10 via one or more antennas. The eNB 12 is coupled via a data/control path 13 to the NCE 14. The path 13 may be implemented as an S1 interface of the LTE system, or a similar interface of other terrestrial systems. The eNB 12 may also be coupled to another eNB via data/control path 15, which may be implemented as the X2 interface of the LTE network or similar for other terrestrial networks.

At least one of the PROGs 10C and 12C is assumed to include program instructions that, when executed by the associated DP, enable the device to operate in accordance with the exemplary embodiments of this invention, as detailed particularly above and more generally below.

That is, the exemplary embodiments of this invention may be implemented at least in part by computer software executable by the DP 10A of the UE 10 and/or by the DP 12A of the eNB 12, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

FIG. 3B illustrates further detail of an exemplary UE in both plan view (left) and sectional view (right), and the invention may be embodied in one or some combination of those more function-specific components. At FIG. 3B the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 3B are seen multiple transmit/receive antennas 36 that are typically used for cellular communication over one or more terrestrial networks 200 and/or the positioning (GPS) network 100. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is fanned. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a GPS receiver 37 and a Bluetooth® radio 39 and a wireless local area network radio (not shown), which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The aforesaid processors 38, 40, 42, 44, 46, 50, if embodied as separate entities in a UE 10 or eNB 12, may operate in a slave relationship to the main processor 10A, 12A, which may then be in a master relationship to them. Embodiments of this invention are most relevant to the main processor 10A which apart from other algorithms (e.g. user applications) typically execute the L1-L3 radio protocol algorithms, though it is noted that other embodiments need not be disposed there but may be disposed across various chips (e.g., the baseband chip 42) and memories as shown or disposed within another processor that combines some of the functions described above for FIG. 3B. Any or all of these various processors of FIG. 3B access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node 12, which may have an array of tower-mounted antennas rather than the two shown at FIG. 3B.

Note that the various chips (e.g., 38, 40, 42, etc.) that were described above may be combined into a fewer number than described and, in a most compact case, may all be embodied physically within a single chip.

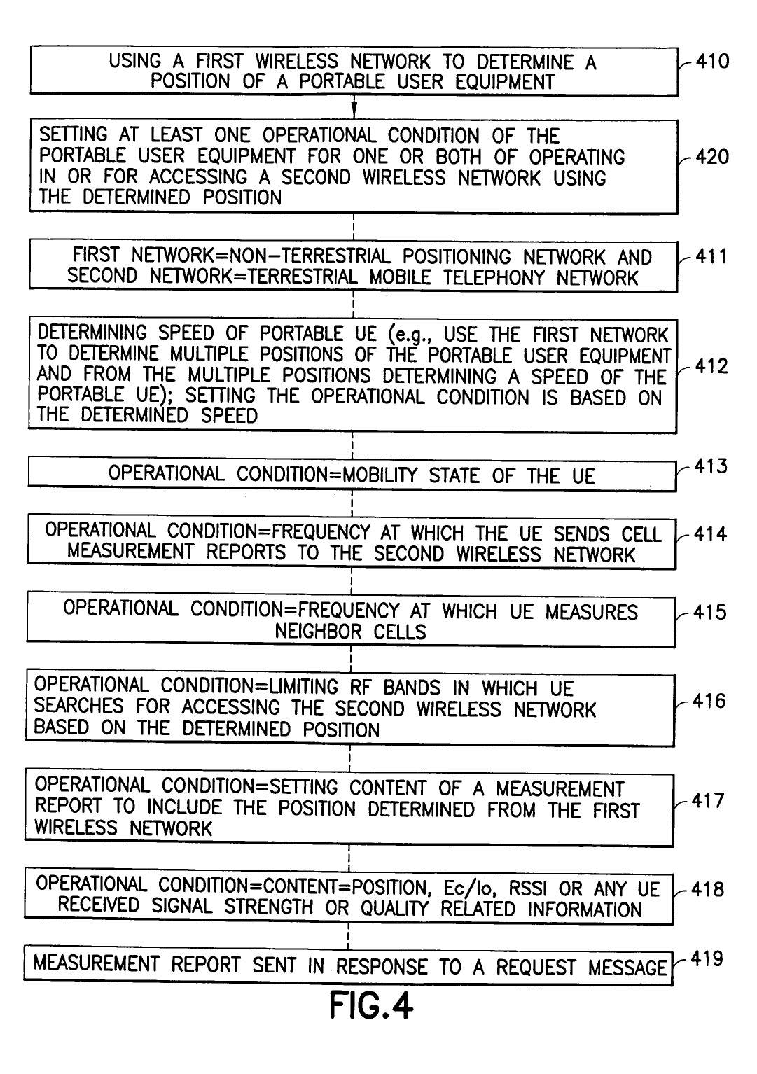

FIG. 4 is a logic flow diagram that illustrates the operation of a more general method than that shown at FIG. 2, and may be, e.g., a result of execution of computer program instructions, in accordance with the exemplary embodiments of this invention.

Based on the foregoing it should be apparent that the exemplary embodiments of this invention provide from the perspective of the portable user equipment a method, apparatus and computer program(s) to use a first wireless network at block 410 to determine a position of a portable user equipment, and to set at block 420 an operational condition of the portable user equipment for operating in or for accessing a second wireless network using the determined position.

At block 411 a particular embodiment is shown of the above in which the first network comprises as a non-limiting example a non-terrestrial positioning network and the second network comprises as a non-limiting example a terrestrial mobile telephony network.

At block 412, which may be a particular embodiment of block 410 alone or as modified with block 411, the method includes determining a speed of the portable UE, which could include using the first network to determine multiple positions of the portable user equipment and from the multiple positions determining the speed of the portable user equipment. As described above, a GPS receiver (e.g., GPS receiver 37) can also supply the speed. Furthermore, the operational condition of the portable user equipment is set based on the determined speed of the portable user equipment.

At block 413, which may be a particular embodiment of block 412, the operational condition is a mobility state of the portable user equipment.

At block 414, which may be a particular embodiment of block 412, the operational condition is a frequency at which the portable user equipment sends cell measurement reports to the second wireless network.

At block 415, which may be a particular embodiment of block 412, the operational condition comprises a frequency at which the portable user equipment measures neighbor cells.

At block 416, which may be a particular embodiment of block 410 alone or as modified with block 411, setting the operational condition of the portable user equipment includes limiting radio frequency bands in which to search for accessing the second wireless network based on the determined position.

At block 417, which may be a particular embodiment of block 410 alone or as modified with block 411, setting the operational condition of the portable user equipment includes setting a content of a measurement report that the portable user equipment sends to the second wireless network to include the position determined from the first wireless network.

At block 418, which may be a particular embodiment of block 417, the content includes an indication of the position, an indication of signal strength of a signal received at the portable user equipment from the second wireless network, and an indication of signal to noise ratio of the signal received at the portable user equipment from the second wireless network.

At block 419, which may be a particular embodiment of block 417, the measurement report is sent to the second wireless network in response to a request message received at the portable user equipment from the second wireless network.

The various blocks shown in FIGS. 2 and 4 may be viewed as method steps, and/or as operations that result from operation of computer program code, and/or as a plurality of coupled logic circuit elements constructed to carry out the associated function(s).

It is noted that many of these blocks can be combined. For instance, block 416 can be combined with any other block.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It is noted that any of the embodiments described may be implemented as computer program, comprising code for performing any of the actions (in combination or not in combination) described above, when the computer program is run on a processor.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

For instance, in an exemplary embodiment an apparatus includes position determining circuitry configured to use a first wireless network to determine a position of a portable user equipment and includes controller circuitry configured to set at least one operational condition of the portable user equipment for one or both of operating in or accessing a second wireless network using the determined position.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be appreciated that the exemplary embodiments of this invention are not limited for use with only this one particular type of terrestrial or non-terrestrial wireless communication system, and that they may be used to advantage in any of various wireless communication systems such as for example E-UTRAN, UTRAN, WCDMA, GSM, etc.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
using a first wireless network to determine a position of a portable user equipment; and
the portable user equipment setting at least one operational condition of the portable user equipment for one or both of operating in or accessing a second wireless network using the determined position.

2. A method according to claim 1, wherein the first network comprises one of a non-terrestrial positioning network or a terrestrial positioning network and the second network comprises a terrestrial mobile telephony network.

3. A method according to claim 1:
further comprising determining a speed of the portable user equipment; and
wherein setting the at least one operational condition of the portable user equipment is based on the determined speed of the portable user equipment.

4. A method according to claim 3, wherein:
determining the speed further comprises using the first network to determine multiple positions of the portable user equipment and from the multiple positions determining the speed of the portable user equipment.

5. A method according to claim 3, wherein the at least one operational condition comprises a mobility state of the portable user equipment.

6. A method according to claim 3, wherein the at least one operational condition comprises a frequency at which the portable user equipment sends cell measurement reports to the second wireless network.

7. A method according to claim 3, wherein the at least one operational condition comprises a frequency at which the portable user equipment measures neighbor cells.

8. A method according to claim 1, wherein setting the at least one operational condition of the portable user equipment comprises setting a content of a measurement report that the portable user equipment sends to the second wireless network to include the position determined from the first wireless network.

9. A method according to claim 8, wherein the content comprises an indication of the position, an indication of signal strength of a signal received at the portable user equipment from the second wireless network, and an indication of signal to noise ratio of the signal received at the portable user equipment from the second wireless network.

10. A method according to claim 8, wherein the measurement report is sent to the second wireless network in response to a request message received at the portable user equipment from the second wireless network.

11. A method according to claim 1, wherein setting the at least one operational condition of the portable user equipment comprises limiting radio frequency bands in which to search for accessing the second wireless network based on the determined position.

12. (canceled)

13. An apparatus comprising:
a radio frequency transceiver;
at least one processor able to communicate with the radio frequency transceiver; and
at least one memory including computer program code,
the at least one memory and the computer program code configured to, with the at least one processor, cause the apparatus to perform at least the following:
using at least the radio frequency transceiver, using a first wireless network to determine a position of the apparatus; and
setting at least one operational condition of the apparatus for one or both of operating in or accessing a second wireless network using the determined position.

14. An apparatus according to claim 13:
further comprising a global positioning system receiver;
wherein using further comprises using a global positioning wireless network to determine the position; and
wherein the second network comprises a terrestrial mobile telephony network.

15. An apparatus according to claim 13, wherein the first network comprises a terrestrial positioning network and the second network comprises a terrestrial mobile telephony network.

16. An apparatus according to claim 13:
wherein the at least one memory and the computer program code are further configured to, with the at least one processor, cause the apparatus to determine a speed of the apparatus; and
wherein setting the at least one operational condition of the apparatus is based at least on the determined speed of the apparatus.

17. An apparatus according to claim 16, wherein the at least one operational condition comprises one, two, or all of the following: a mobility state of the apparatus; a frequency at which the apparatus sends cell measurement reports to the second wireless network; or a frequency at which the apparatus measures neighbor cells.

18. An apparatus according to claim 13, wherein setting the at least one operational condition of the apparatus comprises setting a content of a measurement report that the apparatus sends to the second wireless network to include the position determined from the first wireless network.

19. An apparatus according to claim 18, wherein the content comprises an indication of the position, an indication of signal strength of a signal received at the apparatus from the second wireless network, and an indication of signal to noise ratio of the signal received at the apparatus from the second wireless network.

20. An apparatus according to claim 18, wherein the at least one memory and the computer program code are further configured to, with the at least one processor, cause the apparatus to send, using at least the radio frequency transceiver, the measurement report to the second wireless network in response to a request message received at the apparatus from the second wireless network.

21. An apparatus according to any claim 13, wherein setting the at least one operational condition of the apparatus comprises limiting radio frequency bands in which to search for accessing the second wireless network based on the determined position.

22. (canceled)

23. A computer program product comprising a computer-readable medium bearing computer program code embodied therein for use with a portable user equipment, the computer program code comprising:
code for using a first wireless network to determine a position of the portable user equipment; and
code for causing the portable user equipment to set at least one operational condition of the portable user equipment for one or both of operating in or accessing a second wireless network using the determined position.

24.-45. (canceled)
